(19) United States
(12) Patent Application Publication
(10) Pub. No.: US 2026/0300251 A1
(43) Pub. Date: Oct. 1, 2026

(54) ARTIFICIAL INTELLIGENCE (AI) BASED KNOWLEDGE INDEXER AND PROMPT HANDOVER ENGINE

(71) Applicant: Notion Labs, Inc., San Francisco, CA (US)

(72) Inventors: Simon Townsend-Last, New York, NY (US); Abhishek Kishore Modi, San Francisco, CA (US); Jacob Matthew Sager, San Francisco, CA (US); Phanara Darin Im, San Francisco, CA (US); Kenny Kin Fai Leung, San Francisco, CA (US); Shir Judith Yehoshua, San Francisco, CA (US)

(21) Appl. No.: 19/224,594

(22) Filed: May 30, 2025

Related U.S. Application Data
(60) Provisional application No. 63/779,040, filed on Mar. 27, 2025.

(51) Int. Cl. G06F 16/22; G06F 16/248

(52) U.S. Cl. CPC G06F 16/2291; G06F 16/248

(57) ABSTRACT

A platform can generate and present a GUI selector control that enables users to provide indications of searchable knowledge spaces, such as external systems that provide supplemental information not accessible locally. Based on an indication of a particular searchable knowledge space, the platform can generate an electronic executable including one or more of an an IP address, an API call, or a data source identifier. The platform can use the electronic executable to obtain a supplemental data set and generate a set of embeddings using the data set. A scope identifier, such as a user, block or page identifier, can be associated with the set of embeddings and can be utilized to retrieve the embeddings. In some implementations, embeddings can be automatically accessed when knowledge gaps are identified in response to user queries, such as requests to generate artifacts using information unavailable locally.

### CROSS-REFERENCE TO RELATED APPLICATIONS

This application claims the benefit of priority to U.S. Provisional Application No. 63/779,040, filed Mar. 27, 2025, the contents of which are incorporated by reference in their entirety.

### BACKGROUND

Project management systems enable teams to organize work and can be used in workflow automation, task management, project planning, and file sharing. Some project management systems can be augmented via document management systems, which are designed to manage, track, and store documents, aiming to reduce the use and dependency on physical paper. A document management system can serve as a central repository, making it easy for organizations to organize data.

Many industries are turning to artificial intelligence tools to automate tasks that previously required significant human labor or were infeasible or impossible for humans to perform. However, despite advancement of these tools, integrating them into some types of environments, such as project management systems and/or document management systems, has proven challenging. Conventional tools, for example, lack the inherent capacity to access external knowledge sources. Additionally, conventional tools lack the ability to select and manage knowledge sources that may be needed to answer a user's question, particularly when a specific combination of knowledge sources may be needed. These limitations hamper the ability of artificial intelligence tools to perform tasks seamlessly and efficiently within these environments.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIGS. 3A-3D provide examples of pages, properties, and artificial intelligence (AI) assisted page operations in a block-based data structure of the platform of FIG. 1, according to some arrangements.

FIG. 4 is a diagram showing an example graphical user interface (GUI) for prompt generation in response to detecting a user interaction with a prompt block, according to some arrangements.

FIG. 5 is a diagram showing an example GUI for enabling knowledge source selection, according to some arrangements.

FIG. 6 is a diagram showing an example GUI for performing generative operations using prompt results, according to some arrangements.

FIG. 7A is an example flowchart showing prompt generation and routing operations, according to some arrangements.

FIG. 7B is an example flowchart showing further aspects of prompt routing operations, such as knowledge source indexer and prompt handover operations, according to some arrangements.

FIG. 8 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The technology disclosed herein includes improved systems, methods, and computer-readable media for knowledge indexing and prompt routing.

In some implementations, a platform can generate and present a GUI selector control that enables users to provide indications of searchable knowledge spaces, such as external systems that provide supplemental information not accessible locally. Based on an indication of a particular searchable knowledge space, the platform can generate an electronic executable including one or more of an an IP address, an API call, or a data source identifier. The platform can use the electronic executable to obtain a supplemental data set and generate a set of embeddings using the data set. A scope identifier, such as a user, block or page identifier, can be associated with the set of embeddings and can be utilized to retrieve the embeddings. In some implementations, embeddings can be automatically accessed when knowledge gaps are identified in response to user queries, such as requests to generate artifacts using information unavailable locally.

The platform can receive an input item at a prompt block displayed at a graphical user interface (GUI). Using the input item, the platform can generate a set of C context items corresponding to a set of N facts. The platform can use the set of facts and the set of context items to generating a set of related queries, wherein a first query in the set of related queries is structured to execute against the particular set of blocks to generate a local result set and a second query is structured to execute against an additional knowledge source to generate an additional result set (e.g., to fill automatically identified gaps in local knowledge). The platform can use the local result set and the additional result set to perform generative operations. For example, the platform can generate an artifact that can include locally sourced and additional information.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology includes a block data model (“block model”). For example, the Q&A assistant described herein can automatically analyze and retrieve items (e.g., Rich Text Files (RTF), data, tables, images, audio, multimedia) that are stored and managed using blocks. The prompt generator and/or prompt router described herein can automatically parse user questions (e.g., user questions submitted via the Q&A assistant, UI agent, or another suitable user interface), generate additional prompts and/or questions based on the parsed user questions, and query knowledge sources, which can include items stored in block-based data structure as well as external data.

Generally, blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks or pointers thereto are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the /saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

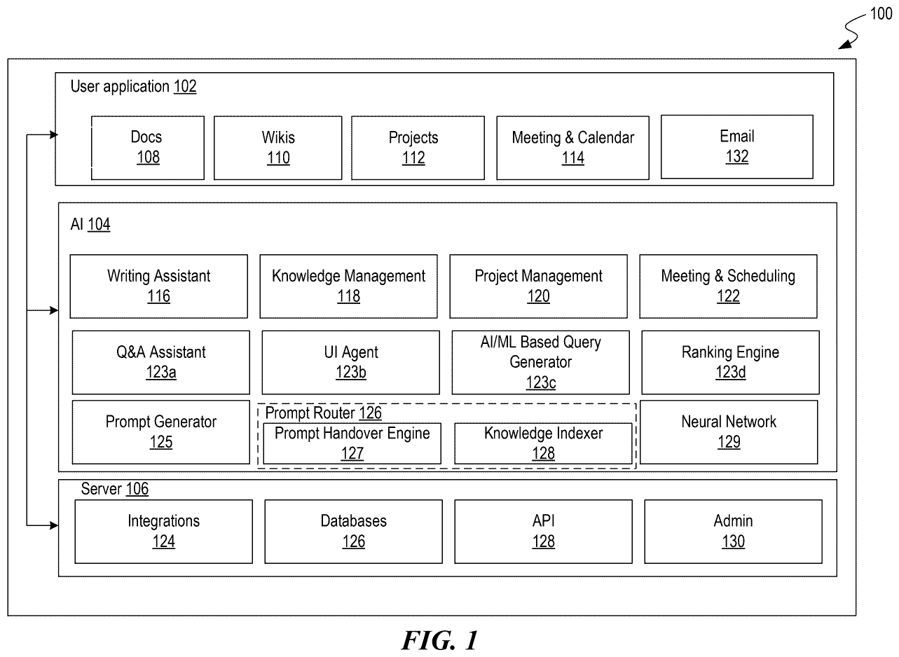

FIG. 1 is a block diagram of an example platform 100. The platform 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 can include a predefined and/or pre-organized set of blocks that can be customized by the user. Blocks are content containers within a template that can include text, images, objects, tables, maps, emails, and/or other pages (e.g., nested pages or sub-pages). Blocks can be assigned certain properties. The blocks are defined by boundaries having dimensions. The boundaries can be visible or non-visible for users. For example, a block can be assigned as a text block (e.g., a block including text content), a heading block (e.g., a block including a heading) or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. In some implementations, the AI prompt block can implement, in whole or in part, the Q&A assistant 123a, UI agent 123b, and/or prompt generator 125. A block can also be assigned to include audio, video, and/or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as artificial intelligence-extracted properties, and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

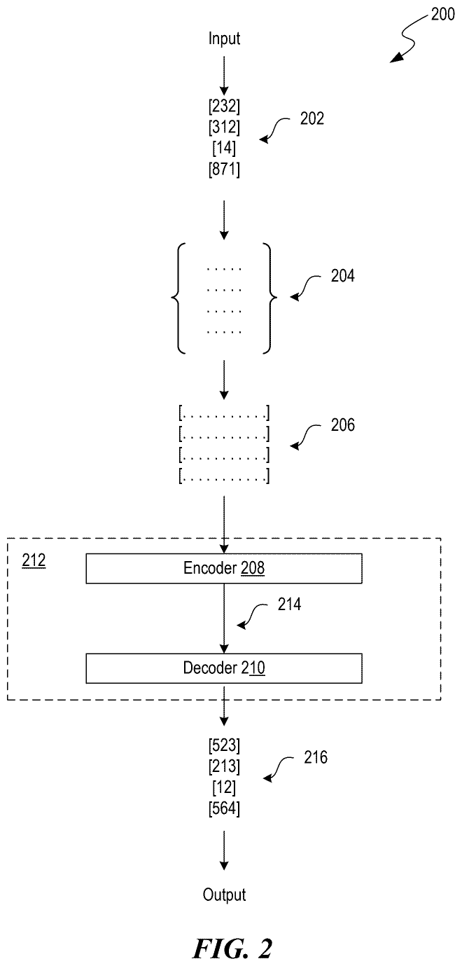

The AI tool 104 is an integrated AI assistant that enables AI-based functions for the user application 102. In one example, the AI tool 104 is based on a neural network architecture, such as the transformer 212 described in FIG. 2. Accordingly, the AI tool 104 can include one or more instances of a neural network 129, which can include model-related data stores, parameter stores, executables, API files, and so forth (collectively, referred to as a model framework).

The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The AI tool 104 can also include a Q&A assistant 123a, UI agent 123b, AI/ML based query generator 123c, and/or a ranking engine 123d. Further, the AI tool 104 can include the prompt generator 125 and prompt router 126, which can include a prompt handover engine 127 and a knowledge indexer 128. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant (e.g., can include some or all of the functionality of the Q&A assistant 123a or UI agent 126). For example, a user can provide instructions on a prompt block to ask a question. In response to receiving the question, the knowledge management tool 118 can provide an answer to the question, for example, based on information included in the wikis template 110 or, more generally, by searching blocks that the requestor has permission to access.

The project management tool 120 can provide AI support for the projects template 112. The AI support can include auto filling information based on changes within the workspace or automatically tracking project development. For example, the project management tool 120 can use AI for task automation, data analysis, real-time monitoring of project development, allocation of resources, and/or risk mitigation.

The meeting and scheduling tool 122 can use AI to organize meeting notes, unify meeting records, list key information from meeting minutes, and/or connect meeting notes with deliverable deadlines.

The Q&A assistant 123a can generate responses to user questions by searching content (e.g., workspaces, databases, pages, blocks) to which the requesting user has access permissions. The Q&A assistant 123a can include or be communicatively coupled to the UI agent 123b, AI/ML based query generator 123c, ranking engine 123d, and/or AI/ML model training engine 123e. In some implementations, the Q&A assistant 123a can include or be communicatively coupled to the prompt generator 125 and prompt router 126. In other implementations, the prompt generator 125 and prompt router 126 can be implemented independently of the Q&A assistant 123a.

The UI agent 123b can enable a user to enter a question, which can be in the form of a natural-language prompt, also sometimes referred to as a natural-language command set or a natural-language instruction set. In some implementations, the UI agent 123b can include a GUI delivered to the client via a user application 102, and the prompt can be received via an input control displayed at the GUI (e.g., a textbox, a prompt block). In some implementations, the UI agent 123b can include or be communicatively coupled to a voice capture device (e.g., a voice-activated assistant, a microphone) that can capture the prompt in auditory form. The UI agent 123b can include a transcription module that converts the auditory-form prompt to text form.

The UI agent 123b can parse the user-entered prompt to extract or determine prompt elements. Prompt elements can include, for example, an instruction, a context, input data, and/or an output specification. For instance, using a natural-language prompt “please provide all recent images of a bear on a bicycle for a children's book illustration”, the UI agent 123b could interpret “provide”, “all”, and “recent” as instructions, “images” as an output specification, “bear on a bicycle” as relevant input data (e.g., knowledge acquired by an AI model via prior training) and “children's book illustration” as context. The UI agent 123b could further pre-process the parsed term “provide” by, for example, cross-referencing it to an ontology of actionable instructions. The ontology of actionable instructions could be further refined based on the additional instructions in the prompt, such as “recent”. For instance, if the term “provide” maps in an ontology to both “retrieve” and “generate”, the UI agent 123b could discard the instruction “generate” by determining that the instruction “recent” refers to previously-generated items.

In some implementations, the UI agent 123b can include or work in conjunction with the prompt generator 125 to implement additional prompt generation logic. For example, the prompt generator 125 can extract or generate a set of facts using the prompt and/or a set of blocks associated with the prompt (e.g., from a particular page on which the prompt block is displayed). The prompt generator 125 can use the set of facts to generate a set of questions, which can be utilized to determine context elements. In such instances, context elements can include identifiers of knowledge sources, which can include page identifiers, block identifiers, identifiers of sets of blocks (parent blocks, child blocks), third-party knowledge source identifiers, supplemental knowledge source identifiers, vector data stores (e.g., third-party platform data vectorized and/or indexed by the knowledge indexer 128), and the like. The context elements, along with the set of questions, can be provided, by the prompt router 126, in the form of queries, function calls, or the like, to appropriate knowledge sources. In some implementations, the queries can be in a format decodable by the platform, such as XML, SQL, API calls, or the like. In some implementations, the queries can be in a format decodable by a third-party data source. The prompt handover engine 127 can utilize the context elements to determine the appropriate query format and generate the queries. In some implementations, the prompt handover engine 127 can also validate result sets, manage parallel query executions or query dependencies (e.g., terminate a query against a particular knowledge source upon detecting that another, similar knowledge source returned results), and so forth.

Accordingly, the UI agent 123b and/or prompt router 126 can provide the prompt elements (instructions, context elements, question sets, input data, and/or output specifications) to a downstream system or module (e.g., the AI/ML based query generator 123c, database 126, prompt handover engine 127, API 128). For instance, the UI agent 123b can generate a set of input features for the AI/ML based query generator 123c and/or prompt generator 125. The AI/ML based query generator 123c and/or prompt generator 125 can use the input features to automatically generate computer-readable and/or computer-executable code, such as a query. For instance, the AI/ML based query generator 123c and/or prompt generator 125 can determine the target database, page, block, and/or teamspace to query based on the prompt elements.

Continuing the example involving bears on bicycles, the AI/ML based query generator 123c and/or prompt generator 125 can include a neural network trained (e.g., using the model training engine 123e) to determine that images (.jpg, .gif) reside in a particular database or collection of linked blocks (e.g., page) titled “IMAGES” and construct at least a portion of the query to search the database or collection of linked blocks titled “IMAGES” for vectorized representation of the content. As another example, if a user “writer” who submitted the request for images that include bears on bicycles has permission to access a particular database titled “STOCK ILLUSTRATIONS”, the AI/ML based query generator 123c and/or prompt generator 125 can set the target database or collection of linked blocks in the automatically generated query string to “STOCK ILLUSTRATIONS”.

Furthermore, items in databases or collections of linked blocks can include properties that denote item categories to facilitate retrieval of data and minimize the size of the retrieved dataset. In such cases, the AI/ML based query generator 123c and/or prompt generator 125 can execute an AI model to determine the category associated with “bear” and/or “bicycle” prior to generating a query. For instance, assuming the AI model returns a classifier “animals” for “bear”, and assuming that the database “STOCK ILLUSTRATIONS” includes a property labeled “animals”, the AI/ML based query generator 123c and/or prompt generator 125 can construct its query (e.g., by generating the “property” portion of the query, the “where” portion of the query, or another syntactical element) to consider only the items in “STOCK ILLUSTRATIONS” where the property value equals “animals”. In some implementations, the AI/ML based query generator 123c and/or prompt generator 125 can generate API calls instead of or in addition to database queries. For instance, the AI/ML based query generator 123c and/or prompt generator 125 can determine a target database 126, determine a particular integration 124 that defines a set of API 128 calls, and automatically generate and execute the appropriate API 128 calls against the database 126.

The UI agent 123b can receive and display, via the GUI, a result set in response to a query or API call. The result set can be post-processed prior to being provided via the GUI. For example, the result set can be used to perform computer-based operations, such as perform arithmetic operations (summation, average, multiplication), perform statistical operations (grouping, sorting, ranking), perform data transformation operations (data type conversion, aggregation, filtering), and the like. In some implementations, computer-based operations can include generative operations. Generative operations involve creating new data, text, images, videos, music, audio, or code that didn't previously exist. Examples include generating random or synthetic data for testing or simulation purposes, creating text summaries or expansions, and producing human-like chatbot responses. Additionally, generative operations can be used to synthesize images and videos, translate images from one style or domain to another, compose original music, generate audio effects or soundscapes, and produce synthetic voice audio. Code generation is another area where generative operations can be applied, including code completion, refactoring, and translation from one programming language to another.

In some implementations, items in the result set can be ranked by the ranking engine 123d. For example, the ranking engine 123d can filter the result set based on relevance to a particular user, a document authority indicator, a similarity indicator (e.g., an indicator denoting a level of similarity between vectorized representation of text data and an input string, an indicator denoting a level of similarity between vectorized representation of an image descriptor and an input string), and so forth. The term “indicator” can refer to measures that include binary values (e.g., 0/1, yes/no), categorical values, scores, probabilities, frequencies and/or aggregations. In some implementations, items in the result set can be further filtered by the ranking engine 123d based on permissions and/or prompt elements. For example, if the instructions specify that “all recent” images of a bear on a bicycle should be retrieved, the ranking engine 123d can translate the term “recent” to a date range and apply the qualifier “all” (e.g., rather than applying the qualifier “top N”) to determine the quantity of ranked items to display in a result set.

Further with respect to elements of the platform 100, the server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc. According to various implementations, the administration unit 130 and/or databases 126 can include various data stores for storage, retrieval and management of ontologies, user accounts, permissions, security settings, AI/ML models, AI/ML frameworks, and so forth.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 2 is a block diagram of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

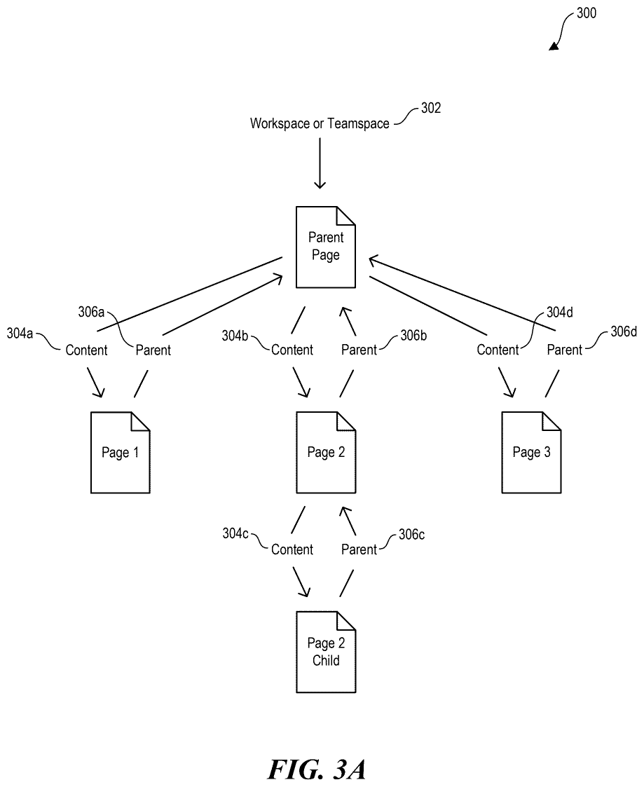

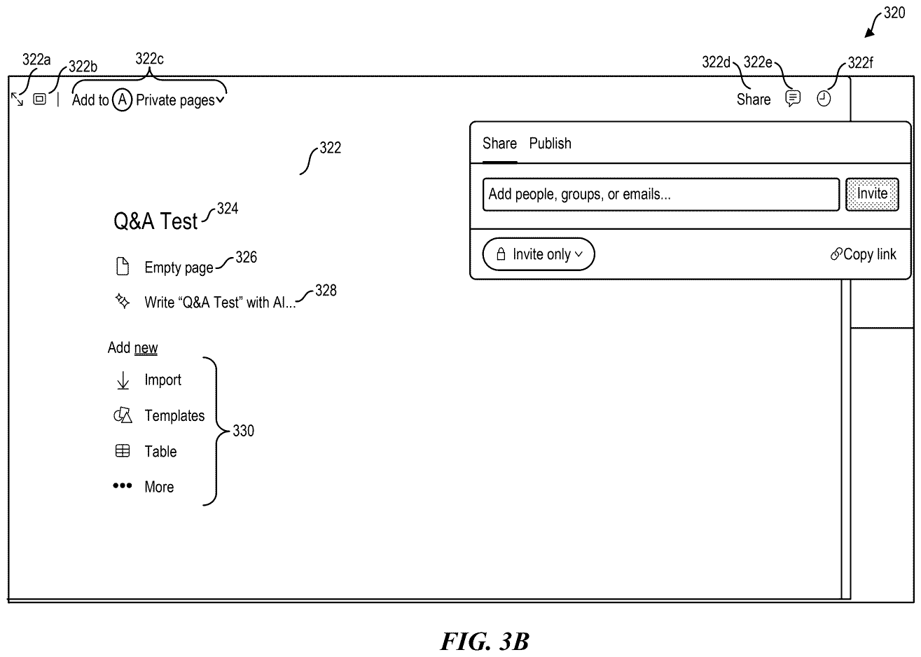

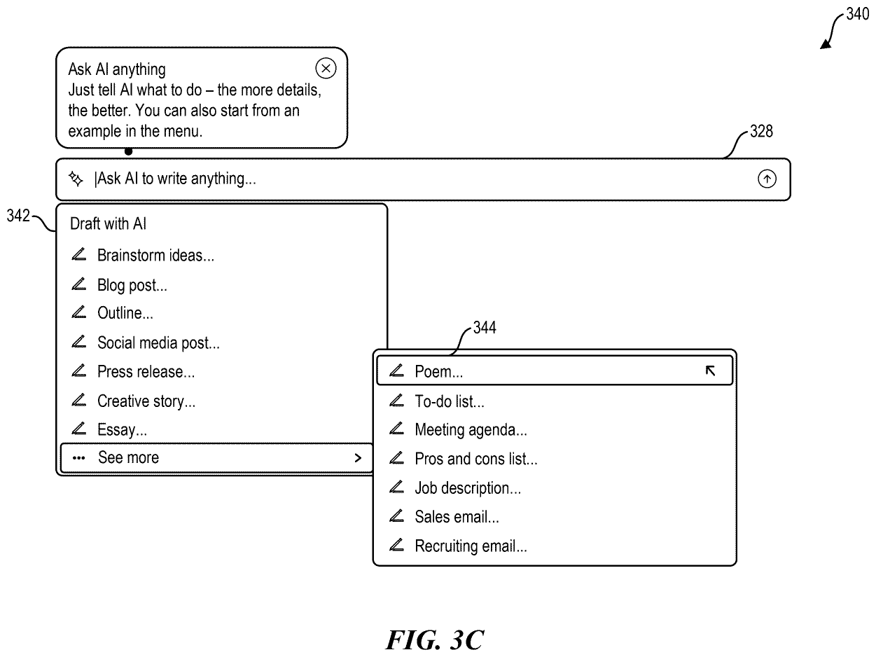

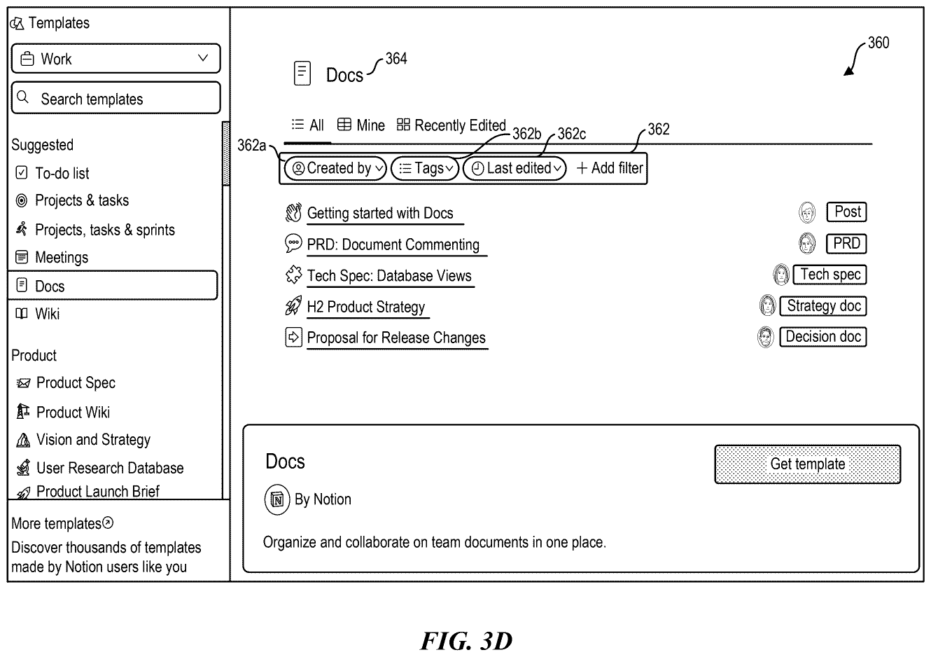

FIG. 3A is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces 302, as shown in FIG. 3A. The page can include a block such as tabs, lists, images, tables, etc.

A teamspace 302 can refer to a collaborative space associated with a team or an organization that is hierarchically below a workspace. For example, a workspace can include a teamspace 302 accessible by all users of an organization and multiple teamspaces 302 that are accessible by users of different teams. Accessibility generally refers to creating, editing, and/or viewing content (e.g., pages) included in the workspace or the one or more teamspaces 302.

In the hierarchical organization illustrated in FIG. 3A, a parent page (e.g., “Parent Page”) is located hierarchically below the workspace or a teamspace 302. The parent page includes three children pages (e.g., “Page 1,” “Page 2,” and “Page 3”). Each of the child pages can further include subpages (e.g., “Page 2 Child” which is a grandchild of “Parent Page” and child of “Page 2”). The “Content” arrows (304a-304d) in FIG. 3A indicate the relationship between the parents and children while the “Parent” arrows (306a-306d) indicate the inheritance of access permissions. The child pages inherit access permission from the (immediate) parent page under which they are located hierarchically (e.g., which is above them in the tree). For example, “Page 2” inherited the access permission of the “Parent page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3A so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

FIG. 3B is an example graphical user interface (GUI) 320 that enables creation of page(s) 322, according to some arrangements. FIG. 3C is an example GUI 340 that enables augmentation of a particular page with AI-generated content, according to some arrangements. FIG. 3D is an example GUI 360 that illustrates aspects of page properties, according to some arrangements. As a general overview, a page can include one or more content blocks and user-interactive controls. The user-interactive controls can enable text generation, text writing, text editing, markdown operations, content management (addition, deletion, merging, import, duplication), template management, content customization, file management (e.g., images, video, audio, multimedia), code generation, database generation, project plan generation, block synchronization, and other generative operations.

Organizing sets of hierarchical blocks in pages provides a host of technical advantages, including the ability to create relational linkages (between blocks and/or pages) in multimodal content, ability to dynamically create multimodal content with various content types added on-demand, ability to synchronize block editing operations when a particular block is included in multiple pages, and ability to optimize multimodal content for AI-based analytical operations such that performance metrics of AI-based models (e.g., accuracy, recall, F-1 score, and so forth) are maximized. For example, when a page includes multimodal content distributed across several blocks, collections of block properties can vary across modalities, which can be represented by blocks, and block properties can serve as built-in data labels to train neural networks on the block structure and content.

A particular page can include textual elements, graphical elements, links, computer-readable code, and/or computer-executable code. As shown in FIG. 3B, an example page 322 includes an expand control 322a, a page positioning control 322b, and an add to control 322c, which enables the user to add the page 322 to a particular teamspace. In some implementations, detecting a user interaction with an add to control 322c causes the GUI 320 to generate and display a list of suggested teamspaces. The list of suggested teamspaces can be determined, for example, by the user's permissions, the user's frequency of interaction with certain teamspaces, the user's recency of interaction with certain teamspaces (e.g., within the past 24 hours, within the past week), and/or the level of authority of a particular teamspace. The example page 322 further includes a share control 322d, which enables the user to cause the platform to generate a link to send to invited collaborators and/or to publish page 322 as a web page. Upon detecting a user interaction indicative of an instruction to publish the page 322 as a web page, the platform can generate and display an additional UI control, which can enable the user to specify a target site, link expiration date, editing permissions, commenting permissions, search engine indexing permissions, settings to enable other people to duplicate a particular public page to their workspaces or teamspaces, and so forth. The example page 322 further includes a view comments control 322e, which enables the user to cause the platform to display comments associated with the page 322. The example page 322 further includes a view changes control 322f, which enables the user to cause the platform to display prior changes associated to content or properties of the page 322.

As shown, the example page 322 further includes a title 324, an empty page control 326, and a prompt block 328. Upon detecting a user interaction with (e.g., clicking on, tapping on, hovering a mouse over) the prompt block 328, the page 322 can cause execution of computer code bound to the prompt block 328. The computer code can, for example, cause the page 320 to generate and display the GUI 340 of FIG. 3C. The GUI 340 can include an expanded prompt block 328, which enables augmentation of the page 320 with content generated by the AI tool 104 of FIG. 1. The user is enabled to enter a natural-language prompt in the prompt block 328, which can trigger, for example, an AI framework (e.g., the transformer framework described in relation to FIG. 2, an LLM, etc.) to generate output in according to the prompt. In some implementations, upon detecting a user interaction with the prompt block 328, the page 322 can cause execution of computer code to display expanded lists 342 and/or 344, which enable the user to further specify prompt elements (e.g., input, context, output, and/or instructions).

As shown, the example page 322 further includes an add new control 330. The add new control 330 enables users to cause the platform to generate content items with predetermined elements, such as format (e.g., a table), layout (e.g., in accordance with a template), and so forth. The add new control 330 can also enable users to import and/or link items (e.g., according to specifications, executables, API definition files, and/or configuration information managed by the integrations 124). Imported items can include, for example, email files (e.g., .msg), .zip files, HTML files, .csv files, text files, markdown files, third-party system files, and so forth. Additionally, the add new control 330 can enable users to add new templates (e.g., project templates, task templates, product-related templates, startup-related templates, operations-related templates, engineering-related templates, design-related templates, human-resources related templates, IT-related templates and so forth), timelines (e.g., Gantt charts), tables, and so forth. The Q&A assistant 123a and/or prompt router 126 can be configured to search content that is linked and/or imported via integrations 124 or via another suitable method of connecting to an external computing system. For example, in various implementations, the Q&A assistant 123a and/or prompt router 126 can access and query linked external content in parallel with querying the block-based data, access and import (e.g., generate blocks and/or embeddings based on) external content, and/or query previously linked and/or imported external content (e.g., content imported using knowledge indexer 128).

Various types of pages that can be added via the add new control 330 can have various attributes, which can include properties. FIG. 3D is an example GUI 360 that illustrates aspects of page properties 362, according to some arrangements. Collections of properties 362 can be predefined for particular templates. For example, a document template 364 can include property collections for blocks in the template. The property collections can, for example, specify the creator 362a, tags 362b, and last edited date/time 362c. As another example, a project template can include properties that include task statuses, task due dates, task assignees, task priorities, task dependencies, and so forth. In some implementations, the GUI enables users to add various custom properties. Some properties can be AI-generated (e.g., AI summary, AI key information, AI custom autofill, AI translation). Some properties can include function calls to integrations, such as Google integrations, GitHub integrations, Figma integrations, Zendesk integrations, and so forth. Properties can include text, numerical information, email addresses, phone numbers, formulas, roll-ups, time stamps, permission information and/or user identifiers, files, media, URLs, and so forth.

The AI tool 104 and/or various modules of the AI tool 104 (e.g., neural network 129) can be trained on block properties, such as properties 362. Block properties can be utilized, alone or in conjunction with other elements, such as block types, block dependencies, block content values, block content types, and/or block format, to train the neural networks of the AI tool 104. Because block property collections do not change as often as block content, and because block property collections can be built-in labels useful for training, training the neural networks of the AI tool 104 on block properties enables the AI tool 104 to be easily incrementally retrained on comparatively smaller data sets, such as property collections or even smaller sets of updates to the property collections. In this manner, the risk of model drift (decay of a model's predictive power as a result of changes in real-world environments) can be managed and reduced such that the model retains predictive relevancy as measured by a suitable performance metric (e.g., accuracy, recall, F-1 score, and so forth).

In an example, the neural network 129 can be trained (e.g., using the model training engine 123e) on various block types, sets of blocks, and their corresponding property collections, such that the Q&A assistant 123a and/or prompt router 126 is enabled to generate executable block queries based on natural-language prompts. For instance, the neural networks can be trained to automatically learn that a particular block type (e.g., “page”) can have a certain property (e.g., “last_updated_date”). As another example, the neural networks can be trained to automatically learn that a particular template (e.g., “shopping list”) can have a certain property (e.g., “tags”, which can include values such as “grocery list”, “books”, “presents”, etc.). Accordingly, when generating response options for an example prompt, “please generate a list of grocery items I have bought more than once lately”, the Q&A assistant 123a, prompt generator 125 and/or prompt router 126 can apply an additional neural network 129 (e.g., prompt tokenizer neural network) trained on template properties to determine that “shopping list[s]” are likely responsive documents. The prompt tokenizer neural network can also be trained on the data values in the “tags” properties of documents (e.g., blocks or collections of blocks) structured according to the template “shopping list”. Accordingly, the prompt tokenizer neural network can further determine that documents tagged “grocery list” are likely responsive. As the next step, the prompt tokenizer neural network can be further trained on content types and/or formats of block content, such that the prompt tokenizer neural network can automatically learn that the user is looking for a set that represents overlapping values across at least two grocery lists. The prompt tokenizer neural network can further use the tokenized representation of “lately” to generate a suitable date range for the “last_updated_date” property across the set of grocery lists (such as, for example, the past two weeks, the past 30 days, the past 180 days and so forth).

### Prompt Generation, Routing and Handover Techniques

As a general overview, the prompt generator 125 and prompt router 126 can enable automatic searches of the block-based data structures described herein to identify, retrieve, analyze, and synthesize information that a particular user has permission to access (e.g., searchable knowledge space). The prompt generator 125 and prompt router 126 can also enable advanced generative operations using prompt results. For example, unlike conventional search applications that can be siloed away, the platform can enable users to take action using the information returned by the prompt generator 125 and/or prompt router 126, including, for example, creation of new pages in a user's workspace. A particular newly created page can include a set of blocks and properties. For example, the particular blocks (content) and properties can be automatically generated based on the returned information. For example, an automatically created meeting agenda can include a set of blocks for action items, which can be automatically generated using the returned information. The items can include hyperlinks to the knowledge sources. The agenda can also include a set of properties (e.g., dates (meeting data, task due date), meeting type, attendee user tags, action owner user tags). Aspects of these and other use cases are further described herein.

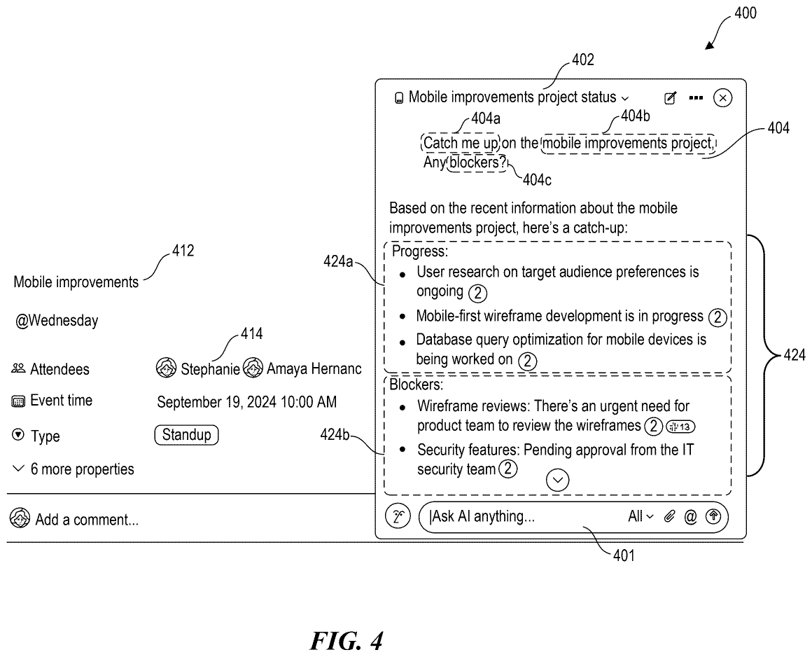

FIG. 4 is a diagram showing an example graphical user interface (GUI) 400 for prompt generation in response to detecting a user interaction with a prompt block, according to some arrangements. As shown, page 410 can include a set of blocks that store content and have associated properties that, collectively, pertain to or describe a particular project 412 (here, the mobile improvements project).

Page 410 can include a prompt block 401, which can enable users to interact with modules of the AI tool 104, such as the prompt generator 125. The prompt block 401 can include a set of computer-executable instructions that regulate and guide the user's input to ensure it is relevant, accurate, and actionable. This can be achieved through techniques such as input validation, conversation flows, error handling, and feedback mechanisms. For example, input validation logic can check user input for correctness, completeness, and/or consistency and auto-complete user input. The input validation logic can (for example, in response to recognizing a particular character) suggest and populate a generative command, user tag, and so forth. The conversation flow logic can guide the user through a structured conversation to gather and/or generate the requested information. For example, the conversation flow logic can include prompting the user for additional information before a response is generated. The additional information blocks can include user-selectable options, menus, and so forth. The items can be presented in the chat window 402. In some implementations, the additional information blocks can include a knowledge source selector menu 502 that can be dynamically presented to a user to prompt the user to specify knowledge sources to answer the user's questions.

Upon detecting a user question entered via the prompt block 401, the prompt generator 125 can parse the user question using tokenization, parts-of-speech recognition, named entity recognition (NER), or other techniques. Tokenization techniques involve breaking down the user's input into individual words or tokens. Part-of-speech tagging techniques involve assigning a category (e.g., a grammatical category) to the extracted tokens—for example, to identify action verbs. NER techniques involve automatically recognizing (e.g., using a trained model, retrieval-augmented search, or other techniques) entity-specific identifiers, such as people, organizations, locations, dates, and so forth.

In some implementations, the prompt generator 125 can break down the user question into up to N facts (e.g., 3, 5, 10 or another suitable number of facts) and generate questions related to the N facts. Using the facts, the prompt generator 125 can generate a set of related and/or sequential queries. For example, the facts and queries can correspond to subsets of tokens, where a particular set of facts includes a subset of tokens that defines the context (knowledge source) C. The encoder 208 of the transformer 212 can convert sets of tokens into vectors 214, and the decoder 210 can attempt to map the vectors to responsive output items. If the decoder 210 determines that it lacks sufficient information within its knowledge base to answer a particular query, the prompt generator 125 can invoke computer-executable logic to determine an appropriate context (e.g., a local or third-party knowledge source).

Using the sets of tokens provided by the prompt generator 125, the prompt router 126 can determine context by applying intent recognition techniques to sets of tokens. For example, a particular set of tokens can reflect factual, procedural, or generative queries. Factual queries may cause the platform to retrieve information from a particular knowledge source. Procedural queries may cause the platform to perform a specific action or task (e.g. execute a script, schedule an appointment). Generative queries may cause the platform to crease new content, such as text, code, or other creative content.

In some instances, the prompt router 126 can determine context by applying domain recognition techniques to sets of tokens. Domain recognition techniques employ advanced natural language processing (NLP) and machine learning algorithms to automatically identify the topic or domain of a user's question or query, and subsequently determine the most relevant data sources to draw upon for a response. These techniques leverage a range of methods, including named entity recognition (NER), which identifies specific entities like project names, task IDs, and team members (e.g., recognizing “Project Alpha” and “Task 123” in the query “What is the status of Project Alpha, specifically Task 123?”), part-of-speech (POS) tagging, which categorizes words based on their grammatical context (e.g., identifying “assign” as a verb in the query “Who is assigned to Task 456?”), dependency parsing, which analyzes sentence structure and relationships between words (e.g., identifying the subject-verb-object relationship in the query “What tasks are due today?”), and semantic role labeling (SRL), which identifies the roles played by entities in a sentence (e.g., recognizing “Who” did “what” to “whom” in the query “Who updated the status of Task 789?”). Additionally, topic modeling techniques, such as latent Dirichlet allocation (LDA), which can uncover underlying themes in a large corpus of text (e.g., identifying “project management” and “task assignment” as related topics in a query about “upcoming deadlines”), and non-negative matrix factorization (NMF), which can reduce dimensionality and identify clusters in high-dimensional data (e.g., grouping similar project tasks based on their status), can be applied to uncover underlying themes and topics in the user's query (e.g., identifying “project status” and “task assignment” as related topics in a query about “current project workload”). By utilizing these domain recognition techniques, the prompt generator can determine the most relevant data sources to draw upon for a response, such as internal or external knowledge sources.

The application of domain recognition techniques can facilitate the identification of knowledge gaps within the platform, enabling the prompt handover engine 127 of the prompt router 126 to recognize when additional information is needed to provide an accurate response. In some implementations, the prompt router 126 can generate a confidence interval or score for local (internal, on-platform) data sources and, if the score is under a predetermined threshold (e.g., 30%, 50%), query a third-party knowledge source to generate a response. For example, if a user asks “What is the current project timeline for Project Alpha?”, the prompt handover engine 127 of the prompt router 126 may recognize that a particular page 410 does not contain the most up-to-date information on the project timeline. Through domain recognition, the prompt handover engine 127 of the prompt router 126 can identify this knowledge gap and automatically reference an auxiliary data source, such as a knowledge source 502, to retrieve the required information and provide a more accurate response.

To make knowledge source access decisions, the prompt handover engine 127 of the prompt router 126 can employ various techniques, including keyword matching, semantic similarity, rule-based approaches, and machine learning. In the context of project management, keyword matching can involve searching for specific keywords related to project databases or data sources, such as “project timeline,” “task assignment,” or “resource allocation”. For instance, if a user asks “What is the current project timeline for Project Alpha?”, the the prompt handover engine 127 of the prompt router 126 can use keyword matching to identify relevant databases or data sources that contain project timeline information. Semantic similarity techniques can be used to compare the semantic meaning of the user's prompt to the schema of potential project management databases. For example, if a user asks “Who is assigned to Task 123?”, the the prompt handover engine 127 of the prompt router 126 can use semantic similarity to identify databases that contain information about task assignments. Rule-based approaches can be employed to trigger database access based on predefined criteria, such as accessing a project management database when a user asks about project status or task deadlines. Finally, machine learning models can be trained to predict the likelihood of needing external project management data based on features in the user's prompt, such as keywords, entities, or intent. For instance, a machine learning model of neural network 129 can be trained to predict that a user's prompt about “project resource allocation” will likely require access to a project management database.

For factual requests (e.g., user searches), the prompt router 126 can cause the generated prompts to be executed against the determined contexts C, receive and validate result sets, and apply analytics to the result sets (e.g., perform extractive summarization) or other AI-based techniques, such as code analysis techniques.

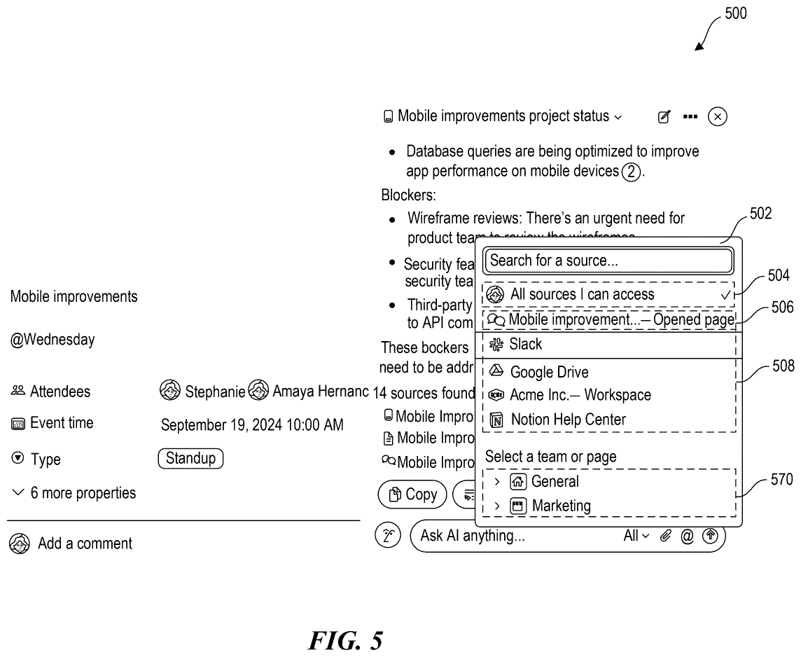

The determined contexts refer to knowledge sources. As shown in FIG. 5, which is a diagram showing an example GUI 500 for enabling knowledge source selection, knowledge sources can be local or external. Local knowledge sources can be identified by absolute references (e.g., page identifier 506) or by relative references (e.g., all allowable pages 504). Additional knowledge sources 508 can include collaboration tools, file storage, workspaces, and the like. In some implementations, the knowledge sources can include allowable knowledge sources for a particular team 510.

To execute a query against an external data source, a third-party knowledge integration technique can be utilized. This technique includes importing a data set from a third-party knowledge source. Various third-party knowledge sources can include collaboration tools, file repositories, project management applications, and so forth. The technique includes vectorizing (creating embedding vectors) and indexing at least a portion of a dataset that corresponds to a particular knowledge source.

In some implementations, the knowledge indexer 128 provides an architecture for efficient capture and storage of items in block-based data structures. The items can include structural units, such as blocks, pages, properties, documents, teamspaces, templates and/or other items. The items can include logical units, such as content, property values, metadata, schemas (e.g., table identifiers, column identifiers, section identifiers, content item identifiers, content item position identifiers, file identifiers), configuration information, and so forth. In an example, the knowledge indexer 128 can access a data set (e.g., a discussion thread in a collaboration tool, a file space and so forth), vectorize items in the data set, link items in the vectorized dataset to items in the block-based data structure of the platform, and monitor the data source for data updates. The knowledge indexer 128 can utilize a vectorization engine, such as a transformer described in relation to FIG. 2. In some implementations, the knowledge indexer 128 can provide, to the vectorization engine, various parameters for vectorization operations, such as encoding format (e.g., float, int, double, base64), maximum number of dimensions, user identifiers, and so forth. The vectorization engine can use a suitable vectorization technique to generate and return a set of embeddings, which can include vectorized representations of the data items. The set of embeddings can be structured as an array, list, collection, memory block, dataset, tabular data file, or in another suitable format. According to various implementations, the embeddings generator can maintain the set of embeddings in memory (e.g., cache), on disk, or both.

In some implementations, the knowledge indexer 128 can modify or transform the set of embeddings before passing it on to downstream systems. For example, the knowledge indexer 128 can add, to a particular set of embeddings, audit information, such as a timestamp, user information, system component identifiers (e.g., URLs and/or MAC addresses) and so forth. More generally, the knowledge indexer 128 can add metadata to items in sets of embeddings. Metadata can include organizational information, such as user identifiers, workspaces, or teamspaces.

The knowledge indexer 128 can access or receive sets of embeddings and store the sets of embeddings in vector databases (e.g., databases 126). The knowledge indexer 128 can generate (or cause the vector database to generate) various optimizations for the sets of embeddings. The optimizations can include indexes. In this context, the term “index” can refer to an organizational unit of vector data, where a vector includes a particular set of embeddings. An index can have various properties, such as a maximum number of dimensions, maximum number of vectors and so forth. In some implementations, the knowledge indexer 128 can bind, to vectors, various metadata. The metadata can be used to filter index records when they are queried. For example, user, workspace, or teamspace identifiers can be included in vector metadata and used to dynamically limit vector searches to sets of vectors that are permissible for the requestor to access. In some implementations, indexes can be further optimized in the vector database to accommodate aspects of the block-based data structure. For example, indexes can be dynamically partitioned into sections (e.g., namespaces) that can correspond to various logical or organizational units within the block-based data structure (e.g., organizations, topics, workspaces, teamspaces, project types, content types, modality types, source systems). Partitioning enables the technical advantage of automatically limiting data sets returned by queries to items that users are permitted to access.

Upon receiving a set of tokens that represent the user question or a system generated question, the prompt router 126 can create an embedding vector representing the set of tokens, retrieve the corresponding embedding vectors for third-party knowledge sources from memory, and compare the embedding vector to the embedding vectors representing a particular third-party knowledge source. To facilitate similarity measurement operations on vectors, a suitable distance metric can be applied to vectorized data. For example, distance metrics for semantic similarity searches can include Euclidian distances, cosine similarity scores, and/or dot-product scores. In some implementations, distance metrics can be selected or determined based on the type of stored data, the type of query, and so forth.

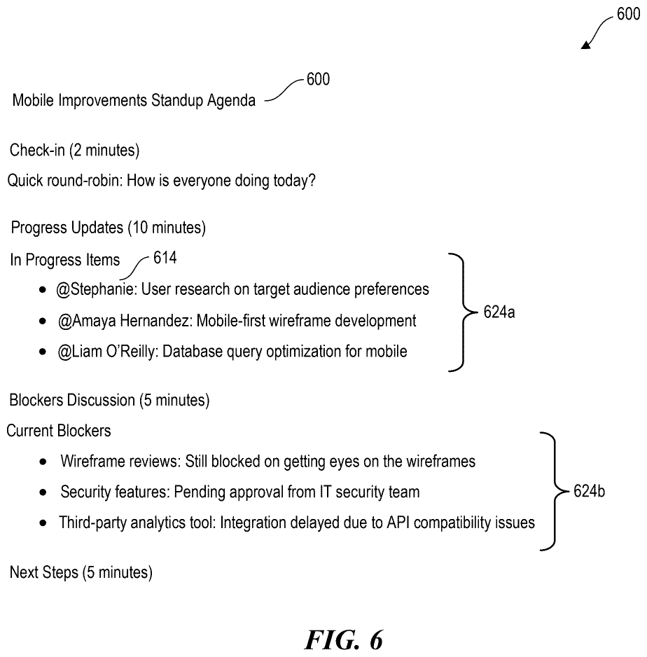

FIG. 6 is a diagram showing an example GUI 600 for performing generative operations using prompt results, according to some arrangements. Generative operations involve creating new data, text, images, videos, music, audio, or code that didn't previously exist. Examples include generating random or synthetic data for testing or simulation purposes, creating text summaries or expansions, and producing human-like chatbot responses. Additionally, generative operations can be used to synthesize images and videos, translate images from one style or domain to another, compose original music, generate audio effects or soundscapes, and produce synthetic voice audio. Code generation is another area where generative operations can be applied, including code completion, refactoring, and translation from one programming language to another.

In a particular use case demonstrated by the sequence of FIGS. 4, 5, and 6, the prompt block 401 can be utilized to receive a user query 404, such as “Catch me up on the mobile improvements project. Any blockers?” The platform can parse an initial set of tokens (“catch me up” 404a, “mobile improvements project” 404b, and “blockers?” 404c). The initial set of tokens can be utilized (e.g., by applying deterministic rules or a trained neural network) to determine user intent. Based on a determination that the user intent is to determine progress and blockers for the project, the platform can generate a set of questions, such as “What progress has been made on the mobile improvement project?” and “What are the blockers for the mobile improvement project?” The questions can be utilized to generate and execute a set of queries and to execute the queries to generate a response set 424, which can include a first response 242a and a second response 424b. The queries can be executed against data sources determined to be relevant. For example, for the “progress” question, the platform can determine that a particular set of blocks (e.g., a set of blocks indicated by items 504 and/or 510, which specify local data sources) should be queried. When executing a query, the platform can search block content, block properties, or both. For the “blockers” question, the platform can determine that no particular set of local blocks is responsive. The platform can apply a trained neural network 129 to determine that a particular third-party data source (e.g., a Slack conversation) identified by a particular keyword can be responsive. The platform can check items 508 to determine whether the user 414 (e.g., the user utilizing the chat window 402) authorized the platform to access the third-party data source. If authorized, the platform can reference a set of indexed vectors that store the relevant data imported from the third-party data source to generate the second response 424b describing project blockers.

The platform can generate and suggest artifact types that can be created using a generative operation. For example, the platform can apply a trained neural network 129 to determine, using the set of tokens (“catch me up” 404a, “mobile improvements project” 404b, and “blockers?” 404c), that commonly requested artifacts for similar questions can include meeting agendas, project status emails, and so forth. Upon detecting a user request, submitted via the prompt block 401 or by interacting with a selectable control in the chat window 402, the platform can generate and display an artifact. As shown, the artifact can be a meeting agenda 600, which can include a first section 624a and a second section 624b. The first section 624a can summarize items from the first response 424a, and can also include tags 614, hyperlinks, or the like. The tags 614 can be citation tags, can reference the content creator, task owner, vector metadata, or other reference information. The second section 624b can include a summary of current blockers, generated using the second response 424b.

### Example Prompt Generation, Routing and Handover Operations

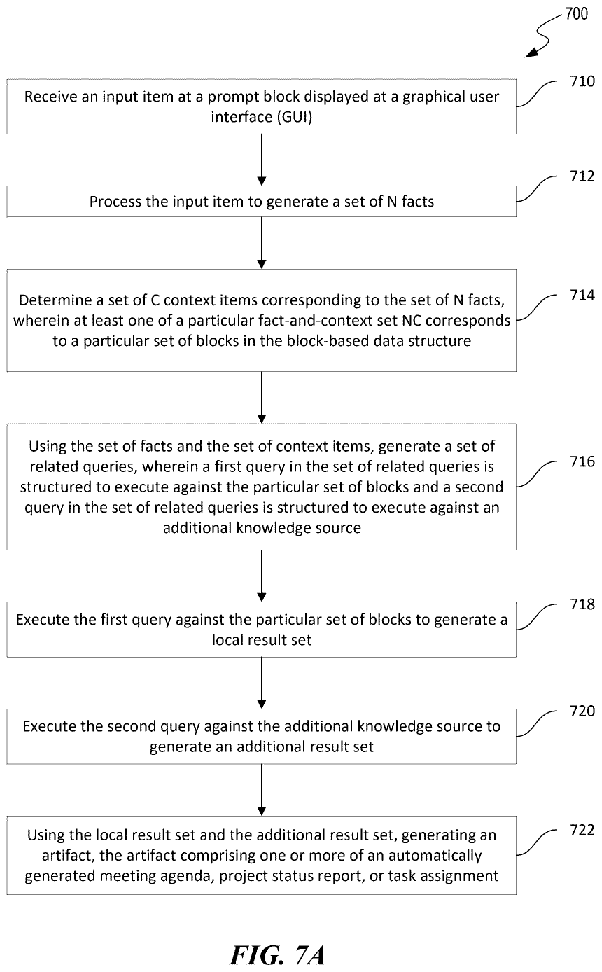

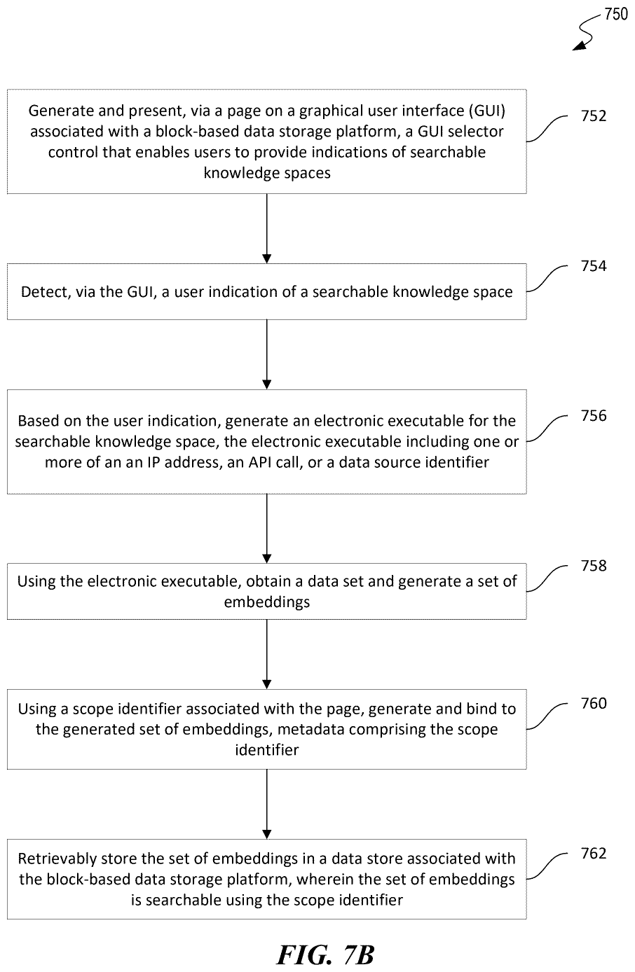

FIG. 7A is an example flowchart showing prompt generation and routing operations 700, according to some arrangements.

At 710, computer-executable operations performed by the platform can include receiving an input item at a prompt block displayed at a graphical user interface (GUI). At 712, computer-executable operations performed by the platform can include processing (e.g., parsing, segmenting, applying a tokenization technique, applying a trained neural network) the input item to generate a set of N facts.

At 714, computer-executable operations performed by the platform can include determining a set of C context items that correspond to the set of N facts. A particular fact-and-context set NC can correspond to a particular set of blocks in a block-based data structure. For example, a particular question or fact can have sufficient information locally in the block-based system to generate a response, and searching content or properties of the relevant blocks can generate the response. In some implementations, however, a particular fact-and-context set NC can include a fact N′ and a subset of contexts C′, the subset of contexts C′ including a first electronic reference to the particular set of blocks and a second electronic reference to an additional knowledge source. In such cases, the operations can include, using at least one of content or properties of the particular set of blocks, generating a responsiveness confidence score (e.g. 1-100) for the particular set of blocks in relation to the fact N′. The operations can include, in response to determining that the responsiveness confidence score is below a predetermined threshold (e.g., 30, 40, 50), performing automatic domain recognition operations using the fact N′ and using an output of the automatic domain recognition operation, generating the second reference to the additional knowledge source. The output can include a topic, an indication of the relevant external data source, and so forth. The second reference can include one or more of an IP address, an API call, or a data source identifier.

At 716, computer-executable operations performed by the platform can include using the set of facts and the set of context items to generate a set of queries, wherein a first query in the set of related queries is structured to execute against the particular set of blocks and a second query in the set of related queries is structured to execute against an additional knowledge source, such as an external knowledge source.

At 718, computer-executable operations performed by the platform can include executing the first query against the particular set of blocks to generate a local result set.

At 720, computer-executable operations performed by the platform can include executing the second query against the additional knowledge source to generate an additional result set. In some aspects, the techniques described herein can include executing the second query against the additional knowledge source to generate an additional result set by: generating a first set of embeddings based on the fact N′; detecting, via the GUI, a user indication of a searchable knowledge space; accessing a second set of embeddings that corresponds to the user indication of the searchable knowledge space; and comparing the first set of embeddings to a second set of embeddings to generate the additional result set. The additional result set can include a responsive subset of embeddings from the second set of embeddings.

In some implementations, the techniques can include generating a local responsiveness score (e.g., 1-100) for the local result set an additional responsiveness score (e.g., 1-100) for the additional result set. Using the local responsiveness score and the additional responsiveness score, a result set R can be generated. The result set R can include ranked (ordered) items. Further, in some implementations, the techniques described herein can include generating and adding, to the result set R, a set of electronic citations including a set of hyperlinks, and including the set of electronic citations in an artifact generated using the result set R.

At 722, computer-executable operations performed by the platform can include using the local result set and the additional result set to generate an artifact, the artifact including one or more of an automatically generated meeting agenda, project status report, task assignment, or another item (e.g., image, text, and so forth).

### Example Indexing Operations

FIG. 7B is an example flowchart showing further aspects of prompt routing operations, such as knowledge source indexer operations 750, according to some arrangements.

At 752, computer-executable operations performed by the platform can include generating and presenting, via a page on a graphical user interface (GUI) associated with a block-based data storage platform, a GUI selector control that enables users to provide indications of searchable knowledge spaces. The searchable knowledge spaces can include various third-party platforms, such as platforms made available via integrations 124.

At 754, computer-executable operations include detecting, via the GUI, a user indication of a searchable knowledge space.

At 756, computer-executable operations include, based on the user indication, generating an electronic executable for the searchable knowledge space. The electronic executable can include one or more of an an IP address, an API call, a data source identifier, or another suitable identifier sufficient to identify and/or navigate to (e.g., in an addressable space) the third-party system.

At 758, computer-executable operations include, using the electronic executable, obtaining a data set and a set of embeddings. For example, a data set can be retrieved or downloaded from the third-party system and vectorized.

At 760, computer-executable operations include, using a scope identifier associated with the page, generating and binding to the generated set of embeddings metadata including the scope identifier. The scope identifier can be one or more of a set of teamspace identifiers, a set of user identifiers, a set of block identifiers, or a set of block properties. The metadata can be bound (linked, associated with) a particular set of embeddings (e.g., an index) such that the embeddings can be made accessible or retrievable using the metadata. In some aspects, the techniques described herein include generating and storing, relationally to a particular block of the page, a property navigable to retrieve the set of embeddings and cross-referencing the property to the scope identifier in the metadata to retrieve the set of embeddings. For example, a user can navigate to a block or page property that indicates a Google Docs integration, a Slack integration, and so forth. Selecting the property can take the user to the corresponding Google Docs page, Slack channel, and so forth. The user can be authenticated by accessing previously generated access credentials or tokens, or by redirecting the user to a single sign-on page structured to authenticate the user.

In some aspects, the techniques described include receiving, at a prompt block displayed at the GUI, a user question; using the user question, generating a set of N facts; determining a set of C context items corresponding to the set of N facts, wherein a first particular fact-and-context set NC corresponds to a particular set of blocks on the page and a second particular fact-and-context set NC′ corresponds to the searchable knowledge space; generating and executing a first query against the particular set of blocks to generate a local result set; and generating and executing a second query against the set of embeddings to generate an additional result set; and displaying at least a portion of the local result set, the additional result set, or both, on the page.

At 762, computer-executable operations include retrievably storing the set of embeddings in a data store associated with the block-based data storage platform, wherein the set of embeddings is searchable using the scope identifier.

In some aspects, the techniques described herein can include generating an artifact using the local result set and the additional result set. The artifact can be personalized for the user by including a reference to a task assignable to the user, by including information about projects or pages relevant to the user, and so forth.

### Computer System

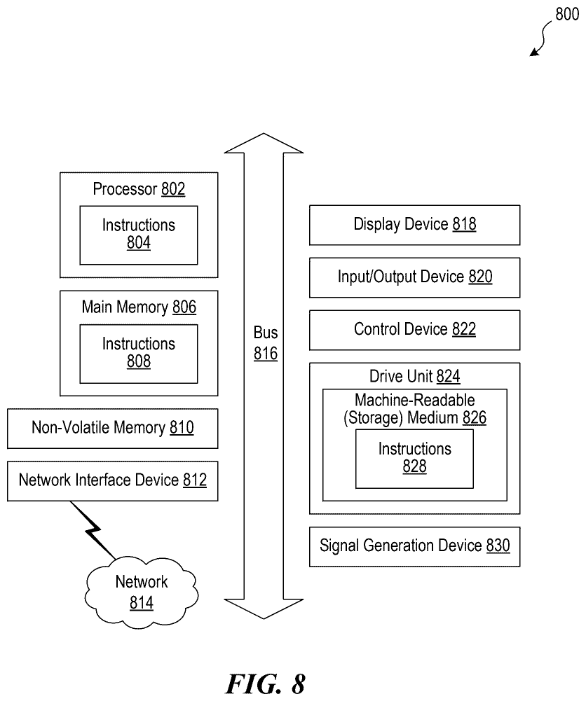

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a display device 818, an input/output device 820, a control device 822 (e.g., keyboard and pointing device), a drive unit 824 that includes a machine readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computer system 800 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 800. In some implementations, the computer system 800 can be an embedded computer system, a system-on-chip (SOC), a single-board computer (SBC) system, or a distributed system such as a mesh of computer systems or include one or more cloud components in one or more networks. Where appropriate, one or more computer systems 800 can perform operations in real time, near real time, or in batch mode.

The network interface device 812 enables the computer system 800 to mediate data in a network 814 with an entity that is external to the computer system 800 through any communication protocol supported by the computer system 800 and the external entity. Examples of the network interface device 812 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computer system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computer system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. One or more non-transitory, computer-readable storage media comprising instructions recorded thereon, wherein the instructions, when executed by at least one data processor of a computing system, cause the computing system to perform knowledge source indexing operations for prompt handover in a block-based content management system, the operations comprising:
generating and presenting, via a page on a graphical user interface (GUI) associated with a block-based data storage platform, a GUI selector control that enables users to provide indications of searchable knowledge spaces;
detecting, via the GUI, a user indication of a searchable knowledge space;
based on the user indication, generating an electronic executable for the searchable knowledge space, the electronic executable including one or more of an an IP address, an API call, or a data source identifier;
using the electronic executable, obtaining a data set;
generate a set of embeddings using the data set;
using a scope identifier associated with the page, generating and binding to the generated set of embeddings metadata comprising the scope identifier; and
retrievably storing the set of embeddings in a data store associated with the block-based data storage platform, wherein the set of embeddings is searchable using the scope identifier.

2. The one or more non-transitory, computer-readable storage media of claim 1, wherein the scope identifier includes one or more of a set of teamspace identifiers, a set of user identifiers, a set of block identifiers, or a set of block properties.

3. The one or more non-transitory, computer-readable storage media of claim 2, the instructions further comprising:
generating and storing, relationally to a particular block of the page, a property navigable to retrieve the set of embeddings.

4. The one or more non-transitory, computer-readable storage media of claim 3, the instructions further comprising:
cross-referencing the property to the scope identifier in the metadata to retrieve the set of embeddings.

5. The one or more non-transitory, computer-readable storage media of claim 4, the instructions further comprising:
receiving, at a prompt block displayed at the GUI, a user question;
using the user question, generating a set of N facts;
determining a set of C context items corresponding to the set of N facts, wherein a first particular fact-and-context set NC corresponds to a particular set of blocks on the page and a second particular fact-and-context set NC′ corresponds to the searchable knowledge space;
generating and executing a first query against the particular set of blocks to generate a local result set; and
generating and executing a second query against the set of embeddings to generate an additional result set; and
displaying at least a portion of the local result set, the additional result set, or both, on the page.

6. The one or more non-transitory, computer-readable storage media of claim 5, the instructions further comprising generating an artifact using the local result set and the additional result set.

7. The one or more non-transitory, computer-readable storage media of claim 6, wherein the artifact is personalized for the user by including a reference to a task assignable to the user.

8. A computer-implemented method for performing knowledge source indexing operations for prompt handover in a block-based content management system, the method comprising:
generating and presenting, via a page on a graphical user interface (GUI) associated with a block-based data storage platform, a GUI selector control that enables users to provide indications of searchable knowledge spaces;
generating an electronic executable that identifies a searchable knowledge space, the electronic executable including one or more of an an IP address, an API call, or a data source identifier;
using the electronic executable, obtaining a data set;
generating a set of embeddings using the data set;
using a scope identifier associated with the page, generating and binding to the generated set of embeddings metadata comprising the scope identifier; and
retrievably storing the set of embeddings in a data store associated with the block-based data storage platform, wherein the set of embeddings is searchable using the scope identifier.

9. The method of claim 8, wherein the scope identifier includes one or more of a set of teamspace identifiers, a set of user identifiers, a set of block identifiers, or a set of block properties.

10. The method of claim 9, further comprising:
generating and storing, relationally to a particular block of the page, a property
navigable to retrieve the set of embeddings.

11. The method of claim 10, further comprising:
cross-referencing the property to the scope identifier in the metadata to retrieve the set of embeddings.

12. The method of claim 11, further comprising:
receiving, at a prompt block displayed at the GUI, a user question;
using the user question, generating a set of N facts;
determining a set of C context items corresponding to the set of N facts, wherein a first particular fact-and-context set NC corresponds to a particular set of blocks on the page and a second particular fact-and-context set NC′ corresponds to the searchable knowledge space;
generating and executing a first query against the particular set of blocks to generate a local result set; and
generating and executing a second query against the set of embeddings to generate an additional result set; and
displaying at least a portion of the local result set, the additional result set, or both, on the page.

13. The method of claim 12, the instructions further comprising generating an artifact using the local result set and the additional result set.

14. The method of claim 13, wherein the artifact is personalized for the user by including a reference to a task assignable to the user.

15. A computing system comprising one or more non-transitory, computer-readable storage media having instructions recorded thereon, wherein the instructions, when executed by at least one data processor of the computing system, cause the computing system to perform knowledge source indexing operations for prompt handover in a block-based content management system, the operations comprising:
generating and presenting, via a page on a graphical user interface (GUI) associated with a block-based data storage platform, a GUI selector control that enables users to provide indications of searchable knowledge spaces;
based on the user indication, generating an electronic executable that identifies a searchable knowledge space, the electronic executable including one or more of an an IP address, an API call, or a data source identifier;
using the electronic executable, obtaining a data set;
generating a set of embeddings using the data set;
using a scope identifier associated with the page, generating and binding to the generated set of embeddings, metadata comprising the scope identifier; and
retrievably storing the set of embeddings in a data store associated with the block-based data storage platform, wherein the set of embeddings is searchable using the scope identifier.

16. The computing system of claim 15, wherein the scope identifier includes one or more of a set of teamspace identifiers, a set of user identifiers, a set of block identifiers, or a set of block properties.

17. The computing system of claim 16, the instructions further comprising:
generating and storing, relationally to a particular block of the page, a property navigable to retrieve the set of embeddings.

18. The computing system of claim 17, the instructions further comprising:
cross-referencing the property to the scope identifier in the metadata to retrieve the set of embeddings.

19. The computing system of claim 18, the instructions further comprising:
receiving, at a prompt block displayed at the GUI, a user question;
using the user question, generating a set of N facts;
determining a set of C context items corresponding to the set of N facts, wherein a first particular fact-and-context set NC corresponds to a particular set of blocks on the page and a second particular fact-and-context set NC′ corresponds to the searchable knowledge space;
generating and executing a first query against the particular set of blocks to generate a local result set; and
generating and executing a second query against the set of embeddings to generate an additional result set; and
displaying at least a portion of the local result set, the additional result set, or both, on the page.

20. The computing system of claim 19, the instructions further comprising generating an artifact using the local result set and the additional result set.
